(19) United States
(12) Patent Application Publication
(10) Pub. No.: US 2010/0250128 A1
(43) Pub. Date: Sep. 30, 2010

(54) APPARATUS AND COMPUTER PROGRAM FOR PROVIDING NAVIGATIONAL INFORMATION TO A SECONDARY VISUAL USER INTERFACE OF A PORTABLE ELECTRONIC DEVICE AND METHOD OF ASSEMBLING THIS DEVICE

(75) Inventors: Roni Burrell, Tel-Aviv (IL); Tom Jenkins, London (GB); Daniel Dhondt, Espoo (FI); Edwin Shannon, London (GB); Shunjiro Eguchi, Espoo (FI); Joeske Schellen, London (GB); Alejandro Sanguinetti, Helsinki (FI); Zachary Ng, North Point (HK); Manuel Gattinger, London (GB); Lianne Mallett, London (GB); Mattias Andersson, Johanneshov (SE); Nicola Ralston, London (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/744,413

(22) PCT Filed: Nov. 22, 2007
(86) PCT No.: PCT/EP07/10141

§ 371 Date: May 24, 2010

(51) Int. Cl. G01C 21/36; G06F 3/01

(52) U.S. Cl. 701/211; 715/733

(57) ABSTRACT

Apparatus for providing navigational information to a secondary visual user interface of a portable electronic device, the device having primary and secondary visual user interfaces respectively located on different faces of the device, the primary visual user interface for use as a main user output interface of the device and the secondary visual user interface for providing a comparatively simple level of user output, wherein the primary and secondary visual user interfaces are respectively arranged such that the primary user output interface can provide a higher level of navigational information than the secondary user output interface, wherein the apparatus comprises circuitry for providing navigational information to the secondary visual user interface.

### TECHNICAL FIELD

The present invention relates to the field of user interfaces for providing navigation information, associated methods, computer programs and apparatus. Certain embodiments of the invention relate to portable electronic devices, in particular, but not limited to, so-called hand-portable electronic devices which may be hand-held in use (although they may be placed in a cradle in use). Such hand-portable electronic devices include so-called Personal Digital Assistants (PDAs).

The portable electronic devices of the present invention may provide one or more audio/text/video communication functions (e.g. telecommunication, videocommunication, and/or text transmission (Short Message Service (SMS)/Multimedia Message Service (MMS)/emailing) functions), interactive/non-interactive viewing functions (e.g. web-browsing, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Navigational information, obtained from global navigation satellite systems (e.g. Global Position Satellite (GPS) and Galileo), is increasingly being provided, particularly in PDAs. However, the information provided is often overwhelming to a user.

In certain satellite navigation systems, for use in car navigation (but also usable by a pedestrian when it is carried out of the car), the user is presented with a visual representation of the present position on a main screen, and in the corner region of the main screen, the user is presented with information concerning what needs to be done at a forthcoming junction. The information presented in the corner region of the screen may, for example, show a diagrammatic representation of a forthcoming roundabout/junction and show the path a car needs to take around the roundabout/at the junction. This information may be considered to be confusing to a user who is using the satellite navigation system when not driving a car i.e. as a pedestrian.

The listing or discussion of a prior-published document or any background in this specification should not necessarily be taken as an acknowledgement that the document or background is part of the state of the art or is common general knowledge. One or more aspects/embodiments of the present invention may or may not address one or more of the background issues.

### SUMMARY

In a first aspect, there is provided an apparatus for providing navigational information to a secondary visual user interface of a portable electronic device, the device having primary and secondary visual user interfaces located on distinct locations of the device, the primary visual user interface for use as a main user output interface of the device and the secondary visual user interface for providing a comparatively simple level of user output, wherein the primary and secondary visual user interfaces are respectively arranged such that the primary user output interface can provide a higher level of navigational information than the secondary user output interface, wherein the apparatus comprises circuitry for providing navigational information to the secondary visual user interface.

The device may have more than primary visual user interface, the term secondary visual interface is secondary to the one or more primary user interfaces.

The circuitry may be arranged to comprise hardware, and/or hardware appropriately adapted with software for providing navigational information to the secondary user output interface.

The primary and secondary visual user interfaces may be distinctively located on respective different faces of the device. The primary and secondary visual user interfaces may be distinctively located on different portions of the same face of the device.

The primary and secondary visual user interfaces may be respectively located on distinct regions on the face of the device such that the secondary visual user interface is available for viewing when the primary user interface is unavailable for viewing (e.g. in a fully closed or partially closed configuration of the device).

The circuitry may be arranged to provide both the primary and secondary visual user interfaces with navigational information.

The circuitry may be arranged to receive the navigational information from circuitry for receiving and processing navigation information, and provide a redacted form of the navigation information to the user using the secondary visual user interface. The circuitry for receiving and processing navigation information may be circuitry for receiving and processing satellite navigation information and/or circuitry for receiving and processing navigation information provided from cellular information (e.g. Enhanced GPS or navigation systems based on cellular information alone).

The circuitry may be arranged to receive and process navigation information, and provide a redacted form of the information to the user using the secondary visual user interface. The circuitry may receive and process satellite navigation information and/or navigation information provided from cellular information (e.g. Enhanced GPS or navigation systems based on cellular information alone).

The circuitry may be arranged to provide navigational information to both the primary and secondary visual user interfaces. The circuitry may be dedicated to only provide navigational information to the secondary and not the primary visual user interface. The circuitry may be dedicated to only provide navigational information to the secondary visual user interface.

The apparatus may comprise the secondary user interface. The apparatus may comprise the primary user interface.

The circuitry may be arranged to provide the navigational information in the form of a graphical icon (e.g. arrow) and/or textual information indicating distance to next junction/turn.

The circuitry may be arranged to provide the navigational information only in the form of one or more of a graphical icon (e.g. arrow) and/or textual information indicating distance to next junction/turn. The circuitry may be arranged to provide the navigational information in the form respective arrows to indicate one or more of left, right, straight, U-turn at the next junction/turn.

The circuitry may be arranged to provide the navigational information in the form of a compass to indicate direction. The circuitry may be arranged to provide the navigational information in the form of a direction shown on a compass (e.g. S, SW, N, etc.).

The circuitry may be arranged to provide the navigational information to one or more light elements of the secondary user interface. The circuitry may be arranged to provide the navigational information to one or more Light Emitting Diodes (LEDs) of the secondary user interface.

The circuitry may be arranged to provide the navigational information to one or more light elements/Light Emitting Diodes (LEDs) of the secondary user interface by using one or more of number of/colour of/frequency of blinking of light elements/LEDs.

For example, three lit LEDs (out of a maximum of five LEDs) may indicate that you are at the next junction, and one lit LED may indicate that you are 50 metres away from the next junction/turn, two LEDs may indicate that you are 40 metres away, and so on.

As a further example, in the case of a single LED, the lit LED may indicate that you are in proximity to the next turn/junction, the particular proximity based on use conditions (e.g. when the light is on, the very next turn/junction may be indicated in one use condition or, in another use condition, the light only turns on when you are at the particular junction/turn). Similarly, blinking may be used to indicate proximity (for both single and multiple light element embodiments), higher frequency blinking indicating a closer proximity to the next junction/turn than a lower frequency blinking. Following high frequency blinking, the light element may be lit to show extreme close proximity to the next turn/junction.

In the case of colour of light elements, different colour may be used to indicate proximity to the next turn/junction. For example, amber may be used to indicate forthcoming proximity to the next junction/turn, red may be used to indicate that you have passed the junction/turn and green may be used to indicate that you are at the junction/turn.

The secondary visual user interface may be arranged on a minor face of the device, and the primary user interface may be arranged on a major face of device, e.g. in the case of some so-called “mono-block” mobile phones. The minor face may be a lateral side face or a top/bottom lateral face.

The secondary visual user interface may be arranged to be viewed when the device is being carried around the neck of a user using a neck-strap.

The device may have open and closed configurations (e.g. a clam-shell arrangement), the open configuration being a configuration in which the primary visual interface is available for viewing and the closed configuration being a configuration in which the primary visual interface is hidden and the secondary visual user interface is available for viewing.

The apparatus may be arranged to provide the navigational information to a second user interface, which may be removably connected to the portable electronic device. The secondary visual user interface may be located with/on an earpiece for use in hands-free operation (listening/speaking) using the portable electronic device. The secondary visual user interface may be located on a wired transmission path between a connectable earpiece, for use in hands-free operation (listening/speaking) using the portable electronic device, and the connection end of the earpiece.

The circuitry may be arranged to provide the navigational information using an air interface (e.g. short range wireless communication e.g. Bluetooth™) between the apparatus and the secondary visual user interface.

The primary visual user interface may be arranged to additionally allow user input (e.g. a “touch-screen”).

The apparatus may be a module for a portable electronic device. The apparatus may be user interface for a portable electronic device.

A portable electronic device comprising the apparatus of the first aspect.

In a second aspect, there is provided a computer program comprising computer code for an apparatus for providing navigational information to a secondary visual user interface of a portable electronic device, the device having primary and secondary visual user interfaces located on distinct locations of the device, the primary visual user interface for use as a main user output interface of the device and the secondary visual user interface for providing a comparatively simple level of user output, wherein the primary and secondary visual user interfaces are respectively arranged such that the primary user output interface can provide a higher level of navigational information than the secondary user output interface, wherein the computer code is arranged to provide navigational information to the secondary visual user interface.

In a third aspect, there is provided a method of assembling a portable electronic device comprising assembling the apparatus of any preceding claim with one or elements of a portable electronic device.

In a fourth aspect, there is provided a means for providing navigational information to a means for providing secondary visual information to a user of a portable electronic device, the device having means for providing primary and secondary visual information to a user, said means respectively located on distinct locations of the device, the means for providing primary visual user information for use as a main means for user output of the device and the means for providing secondary visual information to a user for providing a comparatively simple level of user output, wherein the means for providing primary and secondary visual user information are respectively arranged such that the means for providing primary visual user information can provide a higher level of navigational information than the means for providing secondary visual user information, wherein the means for providing navigational information is arranged to providing navigational information to the means for providing secondary visual user information.

The present invention includes one or more corresponding aspects, embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:—

FIGS. 1a and 1b show a first embodiment of the present invention comprising a primary and a secondary visual user interface;

FIGS. 2a and 2b show further embodiments of the present invention;

FIGS. 3a and 3b show a third embodiment of the present invention wherein primary and secondary visual user interfaces are provided on a main portion and a removable portion respectively shown in an integrated configuration (FIG. 3a) and a removed configuration (FIG. 3b).

FIG. 4 shows a further configuration of a secondary visual user interface.

### DESCRIPTION OF SPECIFIC EMBODIMENTS

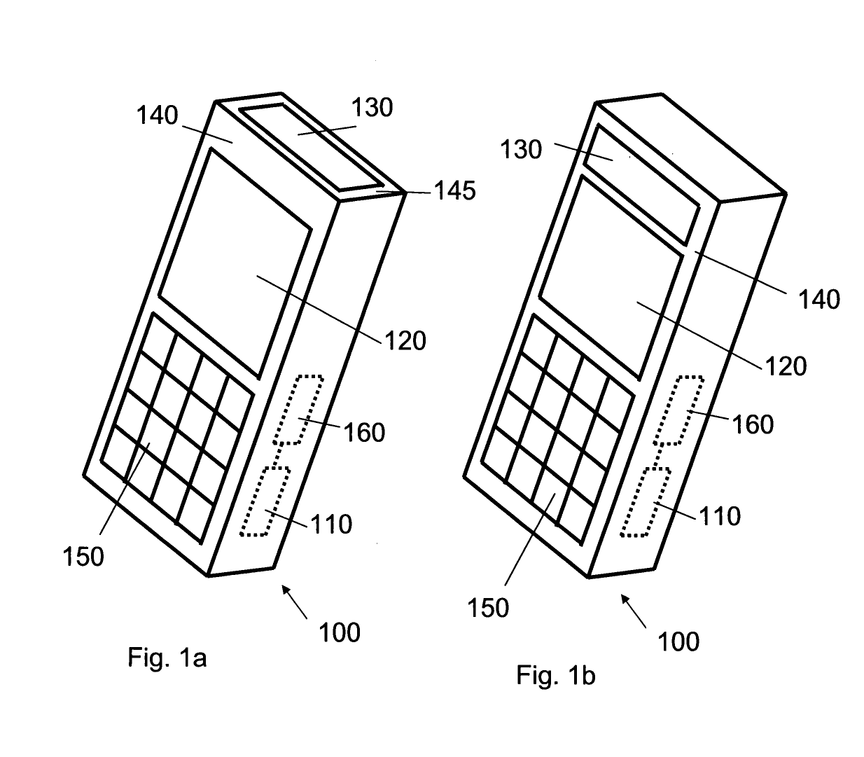

FIG. 1a shows a portable electronic device 100 (in this case a mobile phone) according to a first embodiment of the present invention. The device 100 comprises a primary visual user interface 120, and a secondary visual user interface 130. The primary visual user interface 120 is provided on a front face 140 of the device 100, while the secondary visual user interface 130 is provided on an upper face 145 of the device 100. The device 100 further comprises a user input 150, arranged on the front face 140 of the device 100.

In the present embodiment, both the primary and the secondary visual user interfaces 120, 130 are provided by LCDs, although it will be readily appreciated that any number of further displays may be used. The user input 150 is provided by a keypad, which may comprise pressure pads, be a touch sensitive screen, or the like.

The device 100 further comprises circuitry 110, which comprises both a processor and memory. Both the primary and secondary visual user interfaces 120, 130 as well as the user input 150 are in communication with the circuitry 110. The circuitry 110 is arranged in a known manner to receive input information from the user input as well as output information to both the primary and secondary visual user interfaces 120, 130. The circuitry 110 is programmed with a positioning algorithm, which has location information, such as maps. In the present embodiment, the positioning algorithm is provided by software. However, in alternative embodiments the positioning algorithm may be provided by any one of hardware, firmware, etc.

The device 100 further comprises further circuitry 160 for receiving and processing navigational information. In the present embodiment, the further circuitry 160 is provided by a GPS module 160, arranged to receive and decode GPS signals. The circuitry 110 of the present embodiment is in communication with the GPS module 160, and is arranged to process navigational information therefrom using the positioning algorithm so as to provide a navigational output to both the primary and the secondary visual user interfaces 120, 130.

It will readily be appreciated that, in alternative embodiments, the further circuitry 160 may be arranged to receive and process alternative signals, such as those from Galileo, Glonass, or from pseudolites, or the like. Alternatively, other communication signals may be used for positioning such as U-MTS, GSM, or the like. It will also be readily appreciated that, in an alternative arrangement, the GPS module 160 may be integrated into a single module with the circuitry 110. Similarly while in the present arrangement the GSP module 160 is provided as part of the device 100, it will readily be appreciated that the circuitry 110 may be arranged to receive information, such as by wireless communication, from a further device, said further device comprising the GPS module 160. A person skilled in the art would readily be able to implement such a system.

The circuitry 110 is arranged to provide a relatively detailed navigational output to the primary visual user interface 120, while providing relatively redacted navigational output to the secondary visual user interface 130. In the present embodiment, the primary and the secondary visual user interfaces 120, 130 are considered independently by the circuitry 110. In this regard, one of the primary and the secondary visual user interfaces 120, 130 may be functioning while the other is not.

In the present embodiment, the primary visual user interface 120 is arranged to provide information such as a detailed map, which may be in colour, present location, intended direction, which may be indicated by an arrow, or a series of arrows superimposed upon relevant displayed streets, distance to desired location, present speed of travel, expected arrival time, present time, signal strength, advertising information, etc. The secondary visual user interface 130 is arranged to provide a directional arrow, or the like. The directional arrow is arranged to indicate left, right, straight, U-turn or the like.

In use, a user may select a desired location using the user input 150. The circuitry 110 is then arranged to establish a route to that desired location using information received from the GPS module 160 and the positioning algorithm. The circuitry 110 is then arranged to present that information on both the primary and the secondary visual user interface 120, 130 in a manner as described above. The device 100 is further arranged such that when in a standby mode, i.e. partial power down, the output to the secondary visual user interface 130 remains active, while the output to the primary visual user interface 130 stops.

In such an arrangement a user may, from time to time, observe the secondary visual user interface 130 located on the upper face 145 of the device 100, such as when walking when the device 100 is in a pocket or the like, while the device 100 remains in a standby mode of operation.

If the user wishes to observe, from time to time, further detailed information, he/she may do so by removing the device 100 from standby and consulting the primary visual user interface 120.

While in the above described embodiment, the secondary user interface 130 is provided on an upper face 145 of the device 100, it will readily be appreciated that the secondary visual user interface 130 may be located on many further faces, or regions, of the device 100, such as the front face 140 as shown in FIG. 1b.

In a further embodiment, the device 100 may be a clamshell arrangement. In the clamshell arrangement, the device 100 is arranged to fold about an axis to provide a closed position and an open position. In such an arrangement, the primary visual user interface 120 and the user input 150 may be arranged to be substantially concealed when the device 100 is in the closed position, while the secondary visual user interface 130 remains apparent.

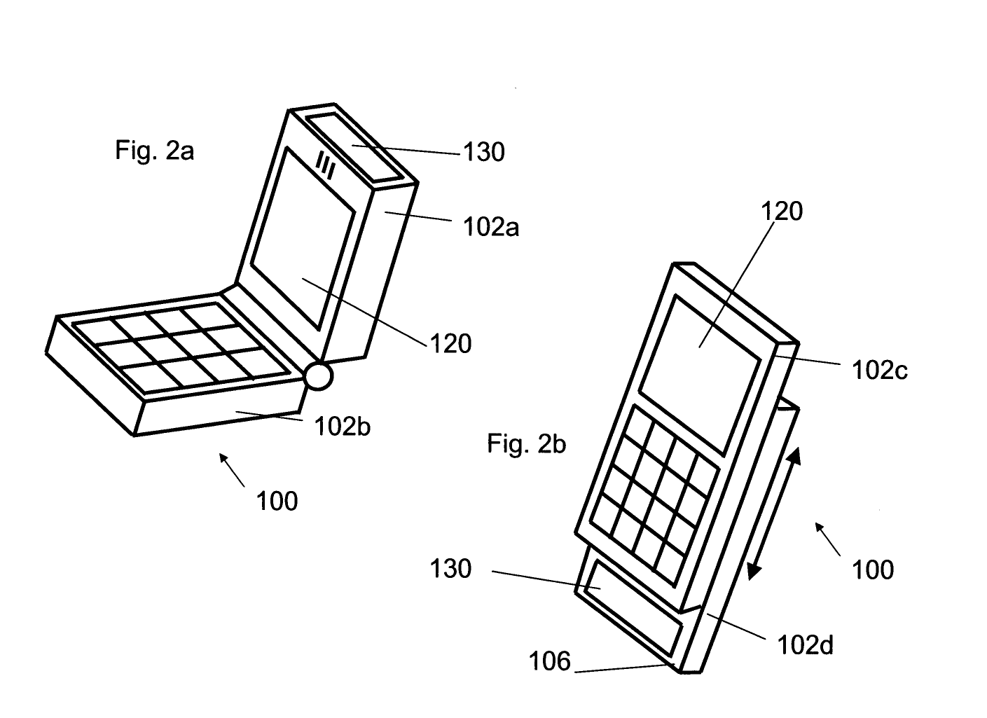

FIG. 2a details an alternative arrangement of the device 100, in which the device 100 is provided with a first portion 102a and a second portion 102b, the first portion 102a being rotatbely connected to the second 102b. In this arrangement the device 100 operates in a so-called clam-shell configuration, such that it can be configured in a first opened position and a second closed position. In this arrangement the secondary visual user interface 130 is provided on a face adjacent the primary visual user interface 120, and is arranged such that when the device 100 is in a closed position, the secondary visual user interface 130 remains visible to a user. When in a closed position both the user input 150 and the primary visual user interface 120 are concealed from a user. It will readily be appreciated that in alternative embodiments, the secondary visual user interface 130 may be provided on alternative or additional one or other faces, such as a face opposing the face on which the primary visual user interface 120 is positioned.

FIG. 2b shows an alternative embodiment of the device 100, in which the device 100 is again provided with a first portion 102c and a second portion 102d. In this arrangement the first portion 102c is slidably connected to the second portion 102d, and arranged such that the portions 102c, 102d are slidably moveable, relative to one another. In this arrangement the portions 102c, 102d are arranged such that the device is configured to operate from a closed position, in which both portions 102c, 102d are substantially aligned, and an open position, in which one portion 102c is substantially moved parallel by a distance relative to the other portion 102d in order to expose a concealed face 106 to a user. In this arrangement the secondary visual user interface 130 is provided on the concealed face 106.

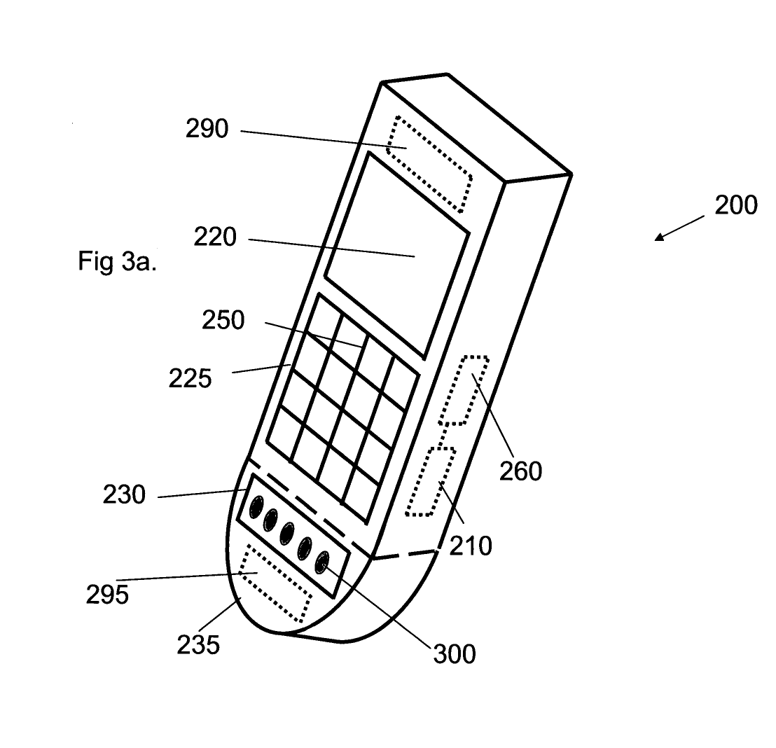

FIG. 3 details a further embodiment of the present invention. In this embodiment, a portable electronic device 200 comprises a main portion 225 and a removable portion 235. The removable portion 235 is removably connectable from the main portion 225. FIG. 3a shows the main portion 225 connected to the removable portion 235, while FIG. 3b shows the main portion 225 detached from the removable portion 235.

In alternative embodiments the removable portion 235 need not be arranged to be able to connect, and be integrated with, the main portion 225 (from a user point of view). In such an arrangement the removable portion 235 may be provided as separate from the device 200, but still in communication with the device 200 as will be described herein.

In the present arrangement a primary visual user interface 220 and a user input 250 are provided on a face 240 of the main portion 225 of device 200, while a secondary visual user interface 230 is provided on the removable portion 235 of the device 200.

In this arrangement the primary visual user interface is provided by an LCD, while the secondary visual user interface is provided by an LED array 300. It will be readily appreciated that any number of further displays may be used. The user input 250 is provided by a keypad.

The main portion 225 of the device 200 further comprises circuitry 210, which comprises both a processor and memory. The main portion 225 of the device 200 further comprises a transmitter 290 arranged to transmit information. In the present embodiment the transmitter 290 is arranged to transmit information using microwave RF, for example using protocols such as Bluetooth, or ZigBee, or the like. The transmitter 290, the primary visual user interface 220 and the user input 240 are in communication with the circuitry 210.

The removable portion 235 further comprises a receiver 295, arranged to receive and process information transmitted by the transmitter 290. The receiver is in communication with the secondary visual user interface 230.

The circuitry 210 is arranged, in a known manner, to receive input information from the user input 240 as well as output information to both the primary visual user interfaces 220 and the transmitter 290. Information output to the transmitter is intended to be received by the receiver 295 of the removable portion 235 and output on the secondary visual user interface 230. The circuitry 210 further comprises a positioning algorithm similar to that described above.

The main portion 225 further comprises further circuitry 160 for receiving and processing navigational information, such as a GPS module 160, arranged to receive GPS signals. In a similar manner to above, the circuitry 210 is in communication with the GPS module 160, and is arranged to process navigational information therefrom using the positioning algorithm so as to provide a navigational output to both the primary and the secondary visual user interfaces 220, 230.

The circuitry 210 is arranged to provide relatively detailed navigational output to the primary visual user interface 220, while providing relatively redacted navigational output to the secondary visual user interface 230. In the present embodiment the primary and the secondary visual user interfaces 220, 230 are considered independently by the circuitry 110. In this regard, one of the primary and the secondary visual user interfaces 220, 230 may be functioning while the other is not.

In the present embodiment, the primary visual user interface 220 is arranged to provide such information as a detailed map, and the like. The secondary visual user interface 230 is arranged output limited information via the LED array 300.

In the present embodiment, the LED array comprises five LEDs. However, in alternative arrangements the LED array may comprise any further number of LEDs such as 2, 3, 4, 10, 50, 100 or any number therebetween. Each LED is arranged to illuminate in an ‘on’ state, as well as illuminate in a blinking, or flashing, state.

In use, a user may select a desired location using the user input 250. The circuitry 210 is then arranged to establish a route to that desired location using information received from the GPS module 260 and the positioning algorithm. The circuitry 210 is then arranged to cause that information as described above to be displayed on the on the primary visual user interface 220. Additionally the circuitry 210 is then arranged to transmit, via the transmitter 290, information regarding the distance from the present location to the next junction that that the user would be required to take.

In such an arrangement the receiver 295 is arranged to receive the information transmitted from the transmitter 290, and is arranged to cause the LED array 300 to illuminate.

In the present embodiment, one LED is illuminated if the user is 50 metres from the next junction; two LEDs are illuminated if the user is 40 metres from the next junction; three LEDs are illuminated if the user is 30 metres from the next junction; four LEDs are illuminated if the user is 20 metres from the next junction; and all five LEDs are illuminated if the user is 10 metres from the next junction. In the present embodiment, when a user is less than 10 meters from the next junction, all the LEDs are arranged to blink, such as at 5 Hertz, or the like.

In further arrangements, the LEDs are arranged to illuminate at different colours, such a red, green, amber or the like, and are arranged so as to indicate the proximity of the user to location, such as the next junction. A person skilled in the art would readily be able to implement such an arrangement.

The device 200 is further arranged such that when in a standby mode, i.e. partial power down, the output to the secondary visual user interface 230 remains, while the output to the primary visual user interface 220 stops. In such an arrangement a user may detach the removable portion 235 and, from time to time, observe the secondary visual user interface 230, such as when walking with the device 200 in a pocket or the like, while the device 200 remains in a standby mode of operation. In such an arrangement, the removable portion 235 may be detached from the main portion 225, and worn on a neck-cord around the user's neck, or placed in his pocket, or worn as a wrist attachment in a known manner, or the like. The main portion 225 may therefore remain in a user's rucksack, suitcase, etc.

If the user wishes to observe, from time to time, further detailed information, they may do so by removing the device 200 from standby and consulting the primary visual user interface 220.

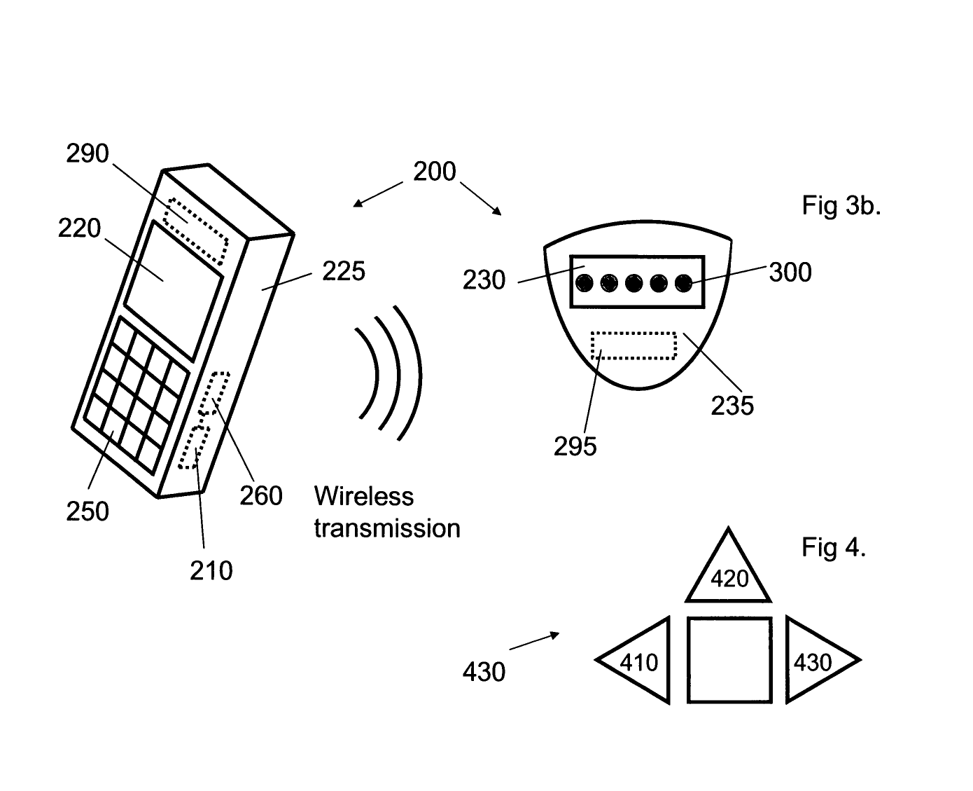

FIG. 4 shows an further exemplary arrangement of a secondary visual user interface 430 in which directional arrows 410, 420, 430, are arranged to illuminate to indicate a user the intended direction of travel. In this arrangement the direction arrows are illuminated by LEDs, covered by translucent diffusers.

It will readily be appreciated that while in the above described embodiment, the secondary user interface 230 is provided with an LED array 300, or directional arrows 410, 420, 430, it may be readily provided by an LCD output as presented in the first embodiment detailed above, and may provide a directional arrow or the like. Additionally, while the provision of a wireless communication between the main portion 225 and the removable portion 235 is described, it will readily be appreciated that this may be wired connection. In such an arrangement, the removable portion may comprise a headset, headphones or the like.

A person skilled in the art will readily be appreciated that any of the features of the first embodiment may be embodied, in combination with or in replacement of, any of the features on the second embodiment and visa versa.

In addition it will be readily appreciated that the device 100, 200 as described above may operate with additional functionality, such as mobile communication, portable video/audio, gaming or the like. In such an arrangement the device 100, 200 may be provided with an audio output, or the like. A skilled reader will readily appreciate that both or either of the primary and secondary visual user interfaces 120, 130 220, 230 may comprise additionally an audio output, which may provide audio information regarding navigation, such as spoken instructions or altering frequency of bleeps depending upon proximity to desired location/next junction, etc.

When the device 100, 200 is arranged in as a communications device, such as a mobile telephone, the device can be further arranged such that it may transmit navigational, or positional information, etc. from the device 100, 200 to further devices. In this arrangement a user may be able to send information, such as by multimedia message, via MMS, to a further user, which may indicate the present output on either or both of the primary visual user interface 120, 220, and the secondary visual user interface 130, 230.

It will be appreciated that the aforementioned device may have other functions in addition to the mentioned functions, and that these functions may be performed by the same device.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-32. (canceled)

33. An apparatus for providing navigational information to a secondary visual user interface of a portable electronic device, the device having primary and secondary visual user interfaces located on distinct locations of the device, the primary visual user interface for use as a main user output interface of the device and the secondary visual user interface for providing a comparatively simple level of user output, wherein the primary and secondary visual user interfaces are respectively arranged such that the primary user output interface can provide a higher level of navigational information than the secondary user output interface, wherein the apparatus comprises circuitry for providing navigational information to the secondary visual user interface.

34. An apparatus according to claim 33, wherein the primary and secondary visual user interfaces are distinctively located on respective different faces of the device or on different portions of the same face of the device.

35. An apparatus according to claim 33, wherein the primary and secondary visual user interfaces are respectively located on distinct regions on the face of the device such that the secondary visual user interface is available for viewing when the primary user interface is unavailable for viewing.

36. An apparatus according to claim 33, wherein the circuitry is arranged to provide both the primary and secondary visual user interfaces with navigational information.

37. An apparatus according to claim 33, wherein the circuitry is arranged to receive the navigational information from circuitry for receiving and processing navigation information, and provide a redacted form of the navigation information to the user using the secondary visual user interface.

38. An apparatus according to claim 33, wherein the circuitry is arranged to receive and process navigation information.

39. An apparatus according to claim 33, wherein the apparatus comprises at least one of the secondary user interface and the primary user interface.

40. An apparatus according to claim 33, wherein the circuitry is arranged to provide the navigational information in the form of one or more of a graphical icon and textual information indicating distance to a next junction.

41. An apparatus according to claim 33, wherein the circuitry is arranged to provide the navigational information in the form of respective arrows to indicate one or more of left, right, straight and U-turn at the next junction.

42. An apparatus according to claim 33, wherein the circuitry is arranged to provide the navigational information to one or more light elements of the secondary user interface, wherein the light elements are light emitting diodes.

43. An apparatus according to claim 33, wherein the circuitry is arranged to provide the navigational information to one or more light elements of the secondary user interface by using one or more light elements.

44. An apparatus according to claim 33, wherein the circuitry is arranged to provide the navigational information using a plurality of light elements, lighting an increasing number of the plurality of light elements associated with proximity to the next turn.

45. An apparatus according to claim 33, wherein the circuitry is arranged to provide navigational information using one or more colors of one or more light elements.

46. An apparatus according to claim 33, wherein the secondary visual user interface is arranged on a minor face of the device and the primary user interface is arranged on a major face of device.

47. An apparatus according to claim 33, wherein the device has open and closed configurations, the open configuration being a configuration in which the primary visual interface is available for viewing and the closed configuration being a configuration in which the primary visual interface is hidden and the secondary visual user interface is available for viewing.

48. An apparatus according to claim 33, wherein the apparatus is arranged to provide the navigational information to a second user interface which is removably connectable to the portable electronic device.

49. An apparatus according to claim 33, wherein the apparatus is arranged to provide the navigational information to a second user interface which is located with an earpiece for use in hands-free operation using the portable electronic device.

50. An apparatus according to claim 33, wherein the apparatus is one of the following; a module for a portable electronic device, a user interface for a portable electronic device.

51. A computer program product comprising computer code for an apparatus for providing navigational information to a secondary visual user interface of a portable electronic device, the device having primary and secondary visual user interfaces located on distinct locations of the device, the primary visual user interface for use as a main user output interface of the device and the secondary visual user interface for providing a comparatively simple level of user output, wherein the primary and secondary visual user interfaces are respectively arranged such that the primary user output interface can provide a higher level of navigational information than the secondary user output interface, wherein the computer code is arranged to provide navigational information to the secondary visual user interface.
